(19) United States
(12) Patent Application Publication
(10) Pub. No.: US 2009/0008170 A1
(43) Pub. Date: Jan. 8, 2009

(54) Multi-plane motorcycle foot peg

(76) Inventor: Travis W. Claussen, Lawson, MO (US)

Correspondence Address: SHUGHART THOMSON & KILROY, PC, 120 WEST 12TH STREET, KANSAS CITY, MO, 64105, US

(21) Appl. No.: 11/824,899

(22) Filed: Jul. 3, 2007

(51) Int. Cl. G05G 1/18

(52) U.S. Cl. 180/90.6

(57) ABSTRACT

A foot peg for a straddled vehicle includes a frame having cross members, each including a row of upper teeth. The cross members are stepped, with the center members higher than the front and rear cross members to define a generally horizontal plane. The front and rear cross members are oriented forwardly or rearwardly at an angle of about 45° to the horizontal step. Each cross member and each adjacent pair of cross members provides a plane of substantially positive engagement by a rider's boot. At least five engagement planes are possible, and the rider's boot may be shifted through a range of at least about 110° while maintaining substantially positive engagement with the foot peg. The frame also includes a pair of inner and outer ends, each equipped with upper teeth. Extensions of the front and rear cross members converge downwardly and inwardly toward the vehicle, forming a brace.

### BACKGROUND OF THE INVENTION

The present disclosure is broadly concerned with a foot support for a motorized straddled vehicle such as a motorcycle, all terrain vehicle, personal watercraft or the like. More particularly, it is concerned with a foot peg having multiple foot-to-peg contact planes for providing a rider with a variety of angles of positive engagement of the foot peg.

Motorsports, in particular motorcycle and all-terrain vehicle racing, time keeping events, rallys and/or stunt sports such as motocross, arenacross, supercross, enduro, motard, pit-bike racing and their many variants, whether amateur or professional, involve high speed maneuvering of a vehicle by a rider over jumps, berms and around turns. These features may be natural terrain or man made and an off road track may also include portions of tarmac for certain events.

In motocross, for example, riders maneuver their bikes to leaps and turns at the edge of traction on a track largely composed of dirt, mud, sand, and/or sawdust. One standard set of motocross obstacles are the so-called “whoops” sections of the track equipped with a series of random staggered bumps generally on a straightaway. Some typical whoops consist of hard packed bumps, which may be slippery, with squared off edges. Experienced riders attempt to skim over the tops of the whoops by picking up the front wheel on approach, accelerating as the back wheel rolls over the top of the first one, while pushing the body back over the rear of the bike to force the back end of the bike down. This method keeps the bike as level as possible so that the front wheel does not drop, in between the whoops. If a rider misjudges and the front wheel drops between the whoops, the bike will be slowed and the rider may be pitched forwardly, over the handlebars.

In order to avoid such spills, riders constantly move their bodies during a race or rally to shift the center of gravity of the bike. They often stand on the foot pegs to use their knees as shock absorbers for high speed landings from heights that may exceed twenty feet. Riders use the cycle handlebars and foot pegs to control such upward, downward, forward, rearward and side-to-side movement and leaning in order to redistribute weight over the wheels of the cycle and to shift the direction and camber of the wheels. A rider may also remove a foot from a foot peg in order to extend the respective leg for use as a counterbalance as, for example, during a turn.

Motocross bikes are typically provided with elongated seats to facilitate the speed with which such weight shifting tactics can be executed. The foot pegs project in orthogonal relation to the longitudinal axis of a bike and are open-topped for quick disengagement by a rider's boot to permit quick leg extension as well as for injury avoidance. They include a generally planar top surface or “ride plane,” for engaging a rider's boot. The outdoor, off-road venue for such sporting events inevitably gives rise to dirt and mud, which coat and encrust riders' boots as well as the foot pegs, reducing boot-to-peg contact.

Various attempts have been made to improve boot traction on the foot pegs by constructing them to pivot about an axis orthogonal to the longitudinal axis of the bike. Such pivoting foot pegs have been criticized for failing to provide a stable base for the rider and their use is widely believed to lead to more frequent spills and increased incidence of ankle breakage and knee dislocation. Attempts have also been made to construct foot pegs in the form of an open skeletal framework to permit passage of dirt and mud, while equipping the upper surface of the framework peg with pins or teeth. While such modifications may limit foot slippage caused by mud or dirt coating the peg, they do not address the need for increased boot-to-peg contact when the rider's feet move forwardly and rearwardly about the axis of the peg while shifting weight to adjust the center of gravity in order to maneuver the cycle.

Accordingly, there is a need for a foot peg for use in off road conditions that provides multiple discrete planes of boot-to-peg contact for substantially positive engagement by a rider's foot in a plurality of angularly varying attitudes.

### SUMMARY OF THE INVENTION

An improved foot peg for a straddled vehicle includes a frame having a plurality of spaced apart, laterally extending cross members, the upper surface of each cross member equipped with a row of teeth. The cross members are positioned in stepped relation, with the intermediate or center cross members being positioned higher than the front and rear cross members to define a generally horizontal step. The front and rear rows are oriented respectively forwardly and rearwardly at an angle of about 45° to a vertical axis. Each row of teeth and each adjacent pair of rows of teeth of the cross members provides a discrete plane of substantially positive engagement by a rider's boot. At least five engagement planes are possible, and the rider's boot may be shifted through a range of at least about 170° while maintaining substantially positive engagement with the foot peg. The frame also includes a pair of inner and outer end members, each having an upper surface equipped with teeth. Extensions of the front and rear cross members converge downwardly and inwardly toward the vehicle to form a brace of the foot peg frame for increased strength and rigidity. A connector bracket is joined with the foot peg for connecting it to the frame of the vehicle.

Various objects and advantages will become apparent from the following description taken in conjunction with the accompanying drawings wherein are set forth, by way of illustration and example, certain embodiments of this foot peg device.

The drawings, including FIGS. 1-6, constitute a part of this specification, include exemplary embodiments of the foot peg, and illustrate various objects and features thereof.

### BRIEF DESCRIPTION OF THE DRAWINGS

FIG. 1 is a perspective view of a left foot peg, with structure for mounting the device to the left side of a wheeled vehicle shown in phantom.

FIG. 2 is a top plan view of the foot peg.

FIG. 3 is a bottom plan view of the foot peg.

FIG. 4 is a sectional view taken along line 4-4 of FIG. 2, showing positive foot engagement planes and a central vertical axis.

FIG. 5 is a front elevational view of the foot peg.

FIG. 6 is a rear elevational view of the foot peg.

### DETAILED DESCRIPTION OF THE INVENTION

As required, detailed embodiments of the foot peg are disclosed herein; however, it is to be understood that the disclosed embodiments are merely exemplary of the device, which may be embodied in various forms. Therefore, specific structural and functional details disclosed herein are not to be interpreted as limiting, but merely as a basis for the claims and as a representative basis for teaching one skilled in the art to variously employ the foot peg in virtually any appropriately detailed structure.

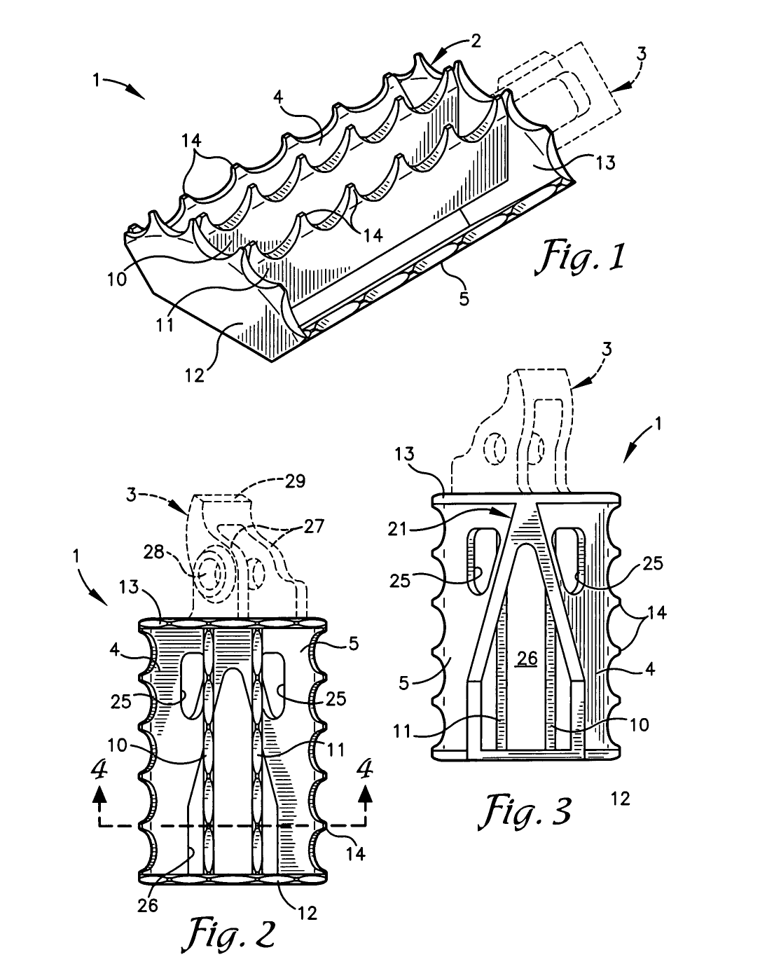

Referring now to the drawing figures, the reference numeral 1 refers to a foot peg for use with a straddled vehicle, which is depicted in FIGS. 1-6. The foot peg 1 includes a frame 2 joined to a connector or mount 3, shown in phantom. The frame 2 presents an approximately rectangular footprint when viewed from above and includes front and rear spars or cross members 4 and 5 and front and rear intermediate cross members 10 and 11 that normally extend laterally from the side of a vehicle when the foot peg 1 is installed on a vehicle in an upright position.

The ends of the cross members are joined in spaced apart relation to each other between a lateral or outer frame end member 12 and a medial or inner frame end member 13. The mount 3 is joined to an outer surface of the inner frame end 13. The upstanding surface of each of the cross members 4, 5, 10 and 11 and each of the outer and inner frame ends 12 and 13 is equipped with positive engagement structure, generally referred to herein as teeth 14. Each cross member with associated teeth 14 forms a laterally extending upper row of teeth, and the outer and inner frame ends 12 and 13 with associated teeth 14 form respective outer and inner longitudinally extending upper rows of teeth on the foot peg frame 2.

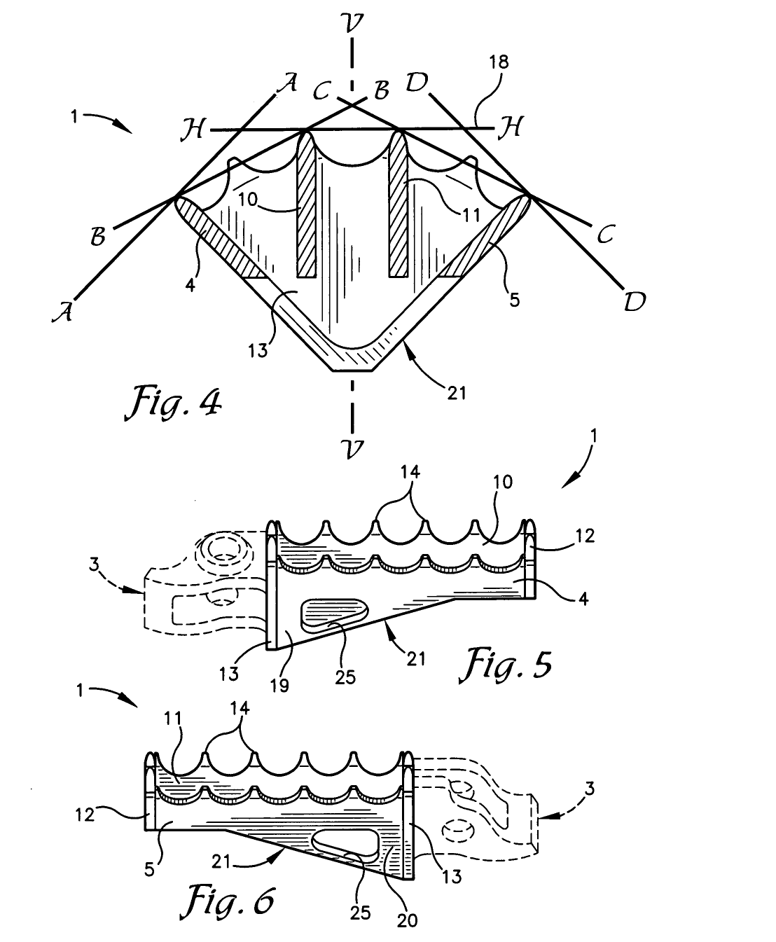

As best shown in FIG. 4, the cross members 4, 5, 10 and 11 and their associated rows of teeth are positioned in vertically stepped relation to provide for substantially positive engagement of the foot peg by a rider's foot or boot in a plurality of angularly varying attitudes. The illustrated intermediate cross members 10 and 11 and their associated rows of teeth 14 are substantially parallel and are positioned higher than the rows of teeth of the front and rear cross members 4 and 5 so that they form a generally horizontal top step 18 defining a plane H-H. While the height of the rows of teeth of the front and rear intermediate cross members 10 and 11 may be about ¼ inch above the heights of the rows of the front and rear cross members 4 and 5, it is foreseen that a vertical protrusion greater or less than ¼ inch may also be beneficial depending on the circumstances in which the bike is intended to be used.

The rows of teeth 14 of the illustrated intermediate cross members 10 and 11 are generally vertically positioned, in generally parallel relation to a vertical axis V-V (FIG. 4). The rows of teeth of the front and rear cross members 4 and 5 are positioned angularly, that is to say they are oriented respectively forwardly and rearwardly, defining respective planes of positive engagement A-A, and D-D. Each row and plane 4, A-A and 5, D-D subtends an angle within a range of from about 5° to about 85°, with a preferred range of from about 30° to about 55°, and a particularly preferred angle of about 45°, all with respect to the vertical rows of teeth of intermediate cross members 10 and 11 and the vertical axis V-V. The rows also subtend a corresponding angle within a range of from about 85° to about 5°, with a preferred range of from about 55° to about 30°, and a particularly preferred angle of about 45°, all with respect to the horizontal step 18, and the horizontal axis H-H (FIG. 4).

Referring to FIG. 4, the rows of teeth of adjacent pairs of cross members, 4 and 10, 10 and 11, and 11 and 5 define five respective planes of positive engagement of the foot peg 1 by a rider's foot or boot. The rows of teeth of front cross member 4 and the adjacent intermediate cross member 10 define a plane of positive engagement B-B; the rows of teeth of intermediate cross member 10 and adjacent intermediate cross member 11 define a substantially horizontal plane of positive engagement H-H as previously described; and the rows of teeth of intermediate cross member 11 and adjacent rear cross member 5 define a plane of positive engagement C-C.

As described, the foot peg 1 includes four laterally extending rows of teeth 14 positioned in vertically stepped relation. However, the intermediate cross members 10 and 11 may also be merged into a single intermediate or center cross member, providing three rows of teeth 14. Such construction would still, however, provide at least five planes of positive engagement for the foot of a rider. Alternatively, additional cross members could be included to provide five, six, seven, eight or any number of laterally extending rows of teeth 14 which, in cooperation with the rows of teeth of adjacent cross members, would define corresponding additional planes of positive engagement.

While the frame 2 is depicted as having a generally skeletal configuration, it may also be constructed to have a more solid form such as, for example, a block supporting laterally extending, spaced apart rows of teeth 14 positioned in spaced apart relation on the frame 2.

As best shown in FIGS. 5 and 6, the front and rear cross members 4 and 5 also each include a respective hem or extension 19 and 20, converging downwardly and inwardly toward the inner frame end 13 to form a brace structure 21 (FIGS. 2 and 3). The extensions 19 and 20 are each provided with a generally outwardly and downwardly oriented aperture 25, while the brace structure 21 and the unextended lower margins of the front and rear cross members 4 and 5 cooperatively form a generally downwardly oriented aperture 26 to permit passage of dirt, mud, rocks and other debris.

The positive engagement structures 14 are generally referred to herein as teeth for the sake of convenience, but the structures are not to be so limited. By way of example, the structures 14 may be triangular, serrated, fluted, substantially scalloped, crenulate, peg-like, pin-like or any other configuration or structure capable of positively engaging the foot or boot of a rider. The structures 14 may include an angular apex, or they may be somewhat flattened at the top as shown in FIGS. 1, 5, and 6. While the teeth 14 are illustrated as being of uniform height and spacing, this need not necessarily be the case. It is foreseen that the spacing and/or heights of the individual engagement structures 14 within a given row may vary somewhat in order to accommodate variations in the soles of the shoes of a rider. It is also foreseen that the lateral or outer members may be slightly raised or lowered to define the camber of the foot peg 1.

An exemplary connector or mount 3 is best shown in FIGS. 2, 3, 5 and 6 and is preferably of unitary construction with the foot peg frame 2. The illustrated mount 3 is configured for attachment to a bracket (not shown) on a vehicle frame and includes a pair of arms 27 positioned in spaced relation to each other for engagement with the bracket. Each of the arms 27 includes an aperture 28 for receiving a connecting fastener or retaining pin (not shown). Stop structure 29 is provided for limiting downward movement of the foot peg 1 when it is kicked from a folded or closed position adjacent a vehicle to an open, generally lateral foot-supporting position. The illustrated mount 3 is one of conventional constructions that may be employed to connect the foot peg 1 to a vehicle, different vehicles requiring different mount configurations. Those skilled in the art will appreciate that any other suitable mount 3 may be employed.

In use, a pair of foot pegs 1 are installed on left and right sides of a vehicle (not shown), preferably a motorized vehicle such as a motorcycle or all terrain vehicle, although the foot pegs 1 may also be used in association with a non-motorized vehicle such as, for example, a bicycle. A rider sits, crouches or stands astride the vehicle with one foot or boot (not shown) on each peg (FIGS. 1-6 depict a left foot peg). As shown in FIG. 4, when the vehicle is in an upright position, the rider's boot positively engages the row of teeth on intermediate cross members 10 and 11 defining plane H-H. When performing a seat bounce during a start or traveling uphill, the rider leans forwardly on the bike, shifting forwardly in the seat and rotating the boots forwardly on the foot pegs 1 so that the boots positively engage the adjacent rows of teeth on front intermediate cross member 10 and the front cross member 4 defining plane B-B. In extreme hills or to perform acrobatics, the rider may shift farther forwardly on the bike, rotating the boots forwardly on the foot pegs 1 so that the boots positively engage the row of teeth on front cross member 4 defining plane A-A. The angle of this row of teeth 4 with respect to the vertical axis V-V is illustrated to be about 45°, and enables the rider's boots to positively engage the foot peg 1 at a forward angle of about 55°.

Similarly, when the bike travels downhill, or when braking, entering a corner navigating a braking bump, the rider leans backwardly and rotates the boots rearwardly on the foot pegs 1 so that the boots positively engage the adjacent rows of teeth on rear intermediate cross member 11 and rear cross member 5 defining plane C-C. In extreme hills or when the rider wishes to lean back on the bike and stand up to redistribute weight, for example, for traversing whoop sections, the rider may shift farther rearwardly on the bike, rotating the boots rearwardly on the foot pegs 1 so that the boots positively engage the row of teeth on rear cross member 5 defining plane D-D. The angle of this row of teeth 5 with respect to the vertical axis V-V is illustrated to be about 45°, which enables the rider's boots to engage the foot peg 1 at a rearward angle of about 55°, the preferred boot position during traverse of whoops.

The positive engagement of the rider's boots with the rows of teeth 14 prevents slippage of the boots off the foot pegs 1 during extreme maneuvers. Since the full range of possible angles of the rows of teeth associated with front cross member 4 and rear cross member 5 is about 5° to about 85° with respect to vertical axis V-V, the rider's foot may be shifted through a range of from about 10° to about 170°, with a particularly preferred range of about 110° from back to front or vice versa and maintain substantially positive engagement with the foot peg 1.

Advantageously, the ability to substantially positively engage the foot peg 1 throughout a plurality of at least five angularly varying attitudes with a full range of motion of about 170°, or a preferred range of about 110° with regard to the axis V-V, enables a rider to move from a far forward leaning position to a far backward leaning position, which may involve seated, crouched or standing positions, while maintaining proper boot-to-peg traction. This extended range of positive engagement of the foot peg 1 by the riders boot greatly enhances the safety of the rider, minimizes the risk of a spill and associated injury, and improves the rider's ability to control the bike.

It is to be understood that while certain forms of the present foot peg have been illustrated and described herein, it is not to be limited to the specific forms or arrangement of parts described and shown.

Having described the preferred embodiments, the following is claimed as new and desired to be secured by Letters Patent:

1. A foot peg for a motorized straddled vehicle, comprising:
(a) a foot peg frame;
(b) a plurality of laterally extending rows of teeth, the rows positioned in spaced apart relation on said foot peg frame; and
(c) said rows being positioned in vertically stepped relation to provide for substantially positive engagement by a rider's foot in a plurality of angularly varying attitudes.

2. The foot peg as set forth in claim 1, including at least three rows of teeth positioned in vertically stepped relation to provide for positive engagement by a rider's foot by engagement with individual rows or adjacent pairs of rows.

3. The foot peg as set forth in claim 2, including:
(a) at least four rows of teeth positioned in vertically stepped relation, and
(b) the two intermediate rows of the teeth defining a generally horizontal top step.

4. The foot peg as set forth in claim 3, including two vertically positioned rows of teeth and two angularly positioned rows of teeth.

5. The foot peg as set forth in claim 4, wherein:
(a) said angularly positioned rows of teeth further comprise a front row and a rear row; and
(b) said front and rear rows each form a respective angle of about 45° to said vertically positioned row of teeth.

6. The foot peg as set forth in claim 1, wherein said rows of teeth provide at least five planes of substantially positive engagement of a rider's foot.

7. The foot peg as set forth in claim 1, wherein a rider's foot may be shifted through a range of at least about 170° and maintain substantially positive engagement with said foot peg.

8. The foot peg as set forth in claim 1, further including:
(a) an outer row of teeth positioned on said foot peg frame; and
(b) an inner row of teeth positioned on said foot peg frame.

9. The foot peg as set forth in claim 1, further including:
(a) a series of apertures in said frame to permit passage of soil and rocks therethrough.

10. A foot peg for connection with a motorized straddled vehicle, and comprising:
(a) a front cross member, a rear cross member and an intermediate cross member, each cross member including an upper row of teeth and a pair of ends;
(b) outer and inner end members joining said respective ends of said cross members in spaced apart relation;
(c) said intermediate cross member positioned higher than said front and rear cross members; and
(d) each row and each adjacent pair of rows of teeth of said cross members providing a respective plane of substantially positive engagement for a rider's foot.

11. The foot peg as set forth in claim 10, wherein said cross members are positioned to enable a rider to support a foot on said foot peg and to shift between a selected one of said respective planes and a selected other one of said planes of positive engagement for a rider's foot.

12. The foot peg as set forth in claim 10, further including:
(a) a pair of intermediate cross members in spaced relation to each other, said pair of intermediate cross members being higher than said front and rear cross members.

13. The foot peg as set forth in claim 12, wherein said intermediate cross members are substantially parallel.

14. The foot peg as set forth in claim 13, wherein said generally parallel intermediate cross members define a substantially horizontal step.

15. The foot peg as set forth in claim 14, wherein:
(a) said rows of teeth of said front and rear cross members are oriented respectively forwardly and rearwardly at an angle of about 45° to said substantially horizontal step.

16. The foot peg as set forth in claim 10, wherein:
(a) said rows of teeth of said front and rear cross members are oriented respectively forwardly and rearwardly at selected angles.

17. The foot peg as set forth in claim 10, wherein:
(a) said cross members and end members form a foot peg frame; and
(b) extensions of said front and rear cross members converge downwardly and inwardly to form a brace structure of said foot peg frame.

18. The foot peg as set forth in claim 10, wherein:
(a) said end members each include an upper row of teeth for positive engagement of a rider's foot.

19. The foot peg as set forth in claim 10, further including:
(a) a connector joined with said foot peg for connecting said foot peg to the frame of a vehicle.

20. A motorcycle foot peg, comprising:
(a) a foot peg frame having a front cross member, a rear cross member and a pair of intermediate cross members, each including an upper surface, a lower surface and a pair of ends;
(b) said frame including outer and inner end members joining said respective ends of said cross members in laterally extending spaced apart parallel relation;
(c) said end members each including an upper surface including teeth;
(d) said cross member upper surfaces including teeth;
(e) said intermediate cross members being positioned in vertically raised relation to said front and rear cross members to provide for positive engagement by a rider's foot in a plurality of angularly varying attitudes;
(f) said intermediate cross members defining a substantially horizontal step;
(g) said teeth of said front and rear cross members each extending respectively forwardly and rearwardly at an angle of about 45° to said substantially horizontal step; and
(h) said cross members being positioned in such a manner as to enable a rider's foot to be shifted through a range of substantially positive engagement of at least about 110°.

21. A foot peg for a motorized straddled vehicle, comprising:
(a) a foot peg frame
(b) a plurality of laterally extending rows of teeth, the rows positioned in spaced apart relation on said foot peg frame;
(c) said rows of teeth including a front row, a rear row and a vertically positioned intermediate row;
(d) said front and rear rows each form a respective acute angle to said vertically positioned row of teeth.

22. The foot peg as set forth in claim 21, wherein said front and rear rows each form an angle of about 45° to said vertically positioned row of teeth.
